(19) United States
(12) Patent Application Publication
(10) Pub. No.: US 2009/0074522 A1
(43) Pub. Date: Mar. 19, 2009

(54) Reduced-friction coatings

(75) Inventors: Michael E. Graham, Evanston, IL (US); Robin A. Koshy, Evanston, IL (US); Laurence D. Marks, Evanston, IL (US)

Correspondence Address: Mr. Edward J. Timmer, P.O. Box 770, Richland, MI, 49083-0770, US

(73) Assignee: Northwestern University

(21) Appl. No.: 12/283,918

(22) Filed: Sep. 16, 2008

Related U.S. Application Data
(60) Provisional application No. 60/994,041, filed on Sep. 17, 2007.

(51) Int. Cl. B23B 27/14; C10M 125/00; C10M 125/20; C10M 125/26

(52) U.S. Cl. 407/119; 508/154; 508/165; 508/155; 508/100

(57) ABSTRACT

A coating is provided having a first metal or non-metal nitride layer and a second metal or non-metal nitride layer wherein the first and second nitride layers are sufficiently resistant to interdiffusion to maintain respective individual layer structure and strength at an elevated operating temperature when a coating contact surface is in sliding contact with another material and wherein one of the first layer or second layer includes a component that is oxidizable at the contact surface to form a friction-reducing lubricous oxide material at the contact surface.

This application claims benefits and priority of provisional application Ser. No. 60/994,041 filed Sep. 17, 2007, the disclosure of which is incorporated herein by reference.

### CONTRACTUAL ORIGIN OF THE INVENTION

This invention was made with government support under contract DMI-0423419 awarded by the National Science Foundation. The U.S. government has certain rights in the invention.

### FIELD OF THE INVENTION

The present invention relates to coatings and, more particularly, to coatings that undergo in-situ oxidation of a coating component to reduce friction at a contact surface as well as to coated tools and other substrates.

### BACKGROUND OF THE INVENTION

Hard coatings for cutting tools have been in use now for thirty years and have evolved from the initial, simple nitride and oxide coatings (such as TiN and Al₂O₃) applied by CVD and PVD in the 1970s, to more complex, high-performance alloy nitrides (such as TAN) employed today.

More recently, the interest in green manufacturing has spurred development of coatings for dry machining. If tools (coatings) can effectively tolerate high temperatures or can help to reduce the temperatures, then coolant usage can be reduced. If the friction level due to the cutting process can be minimized, then lubricant usage can be reduced along with power requirements. To this end, others have explored incorporation of elements that readily oxidize to form lubricious oxides (e.g. V), but which unfortunately diffuse readily to the surface in the host material and result in destabilized structures in the bulk. Still others are looking into the incorporation of low melting metals such as silver, but this too diffuses rapidly to the surface (and to internal surfaces/grain boundaries) and so control of the phase structure and the flux of Ag to the surface is lost.

There is a need for a coating having a structure that remains stable and strong over time on a tool or other substrate and providing for formation of adequate amounts of lubricious oxide at a contact surface where localized elevated temperatures are expected without degrading the properties of the coating below its contact surface.

### SUMMARY OF THE INVENTION

To this end, an embodiment of the present invention provides a composite coating having a first layer comprising a first metal or non-metal nitride and a second layer comprising a second metal or non-metal nitride wherein the first nitride and the second nitride are sufficiently immiscible to maintain respective layer individuality (e.g. respective individual layer structure and strength/hardness) at elevated service temperatures when a contact surface of the coating is in sliding contact with another material and wherein one of the first layer or second layer includes a component that is oxidizable at the contact surface to form a friction-reducing lubricious oxide at the contact surface. The first layer and the second layer may be deposited one on the other in a repeating pattern to provide a multi-nanolayered coating. The first nitride layer and the second nitride layer each can have an individual thickness in the range of 1 to 30 nanometers and an individual hardness at room temperature in the range of 20 GPa to 30 GPa.

In accordance with an illustrative embodiment of the present invention, the first nitride layer comprises a chromium nitride, such as preferably CrN, while the second nitride layer comprises a molybdenum nitride, such as preferably Mo₂N. A non-metal nitride layer or dispersed phase comprises BN.

The invention envisions in accordance with another embodiment a cutting tool comprising a tool substrate and the above coating on the substrate so that little or no lubricant from an external source is required for machining a metallic or other workpiece and a method of cutting a metallic or other workpiece using the cutting tool.

The invention also envisions in another embodiment a bearing surface that comprises a load-bearing substrate and the above described coating on the substrate.

A coating or coated substrate in accordance with the invention is advantageous to save energy through reduced friction and mitigates against excessive wear and temperature increases of a workpiece or member in contact with the coating. Practice of the invention in the machining of metallic workpieces also can help to reduce a major source of industrial waste in the form of contaminated cooling liquids since the metal powder, flakes, curls, etc. resulting from machining can be collected dry and recycled easily and also can help to reduce hazardous mists that can cause respiratory problems in the work place.

A coating in accordance with the invention can be deposited by standard (economical) tool coating methods and replace expensive, and highly specialized coatings such as polycrystalline diamond that are currently used in some machining applications to achieve necessary durability and performance where liquids are not used to cool or lubricate. The coating can have a primary function as in cutting to maintain low friction, or the coating can serve as a fail-safe coating where, under extreme conditions when lubrication is momentarily absent from a contact surface, seizure and failure can be prevented by the coating until lubricant can be supplied in adequate amounts.

Other advantages of the present invention will become more readily apparent from the following detailed description taken in conjunction with the following drawings.

### BRIEF DESCRIPTION OF THE DRAWINGS

FIG. 1 is a schematic view of a multi-layered coating in accordance with an embodiment of the present invention.

FIG. 2 is a schematic view of a coated cutting tool having the multi-layered coating in accordance with an embodiment of the present invention and a workpiece being cut.

FIG. 3 shows deposition rates (Angstroms/minute) and phase regions of CrNₓ and MoNₓ.

FIG. 4 shows the hardness versus periodicity for CrN/Mo₂N multilayers and for CrN and Mo₂N films on Si wafer substrates.

FIG. 5 is a bar graph showing coefficient of friction for CrN/Mo₂N multilayers at room temperature (RT), 300 degrees C., 500 degrees C., and 600 degrees C. as well as for MoO₃ and Mo₂N at room temperature but using the different test parameters of 20 gram load and 52100 steel ball as shown.

### DETAILED DESCRIPTION OF THE INVENTION

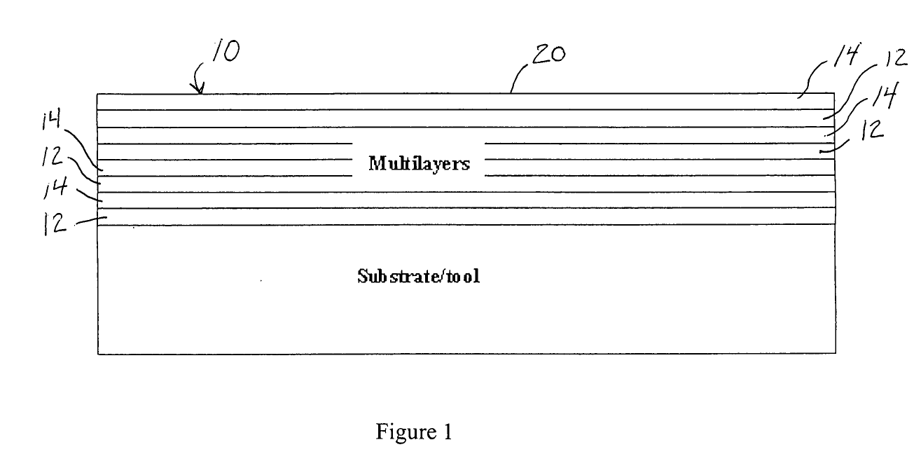

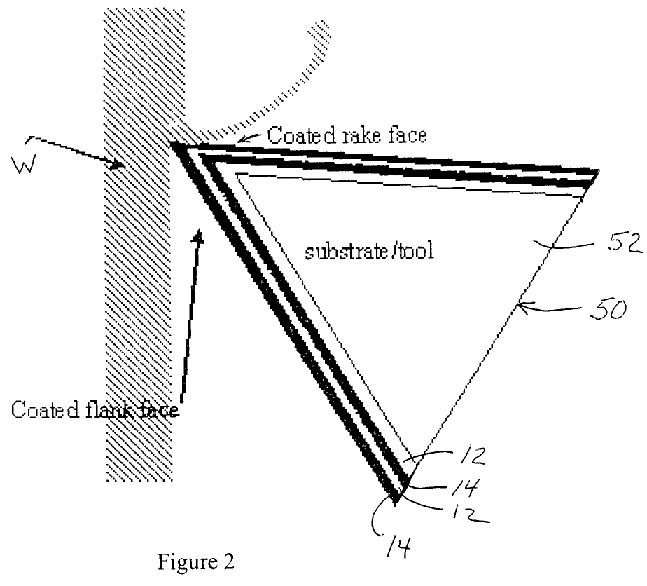

In one embodiment of the invention shown in FIG. 1, a composite coating 10 in accordance with an embodiment of the present invention includes a first layer 12 comprising a first nitride and a second layer 14 comprising a second nitride. The first layer 12 and the second layer 14 can be deposited one on the other on a suitable substrate in a repeating pattern to provide a multi-nanolayered coating, FIG. 1. The first nitride and the second nitride are selected to be sufficiently immiscible (i.e. resistant to interdiffusion) so as to maintain respective layer individuality at an elevated service temperature when a contact surface 20 of the coating is in sliding contact with another material (e.g. workpiece W of FIG. 2). That is, the first nitride layer 12 and the second nitride layer 14 maintain their respective separate individual layer structure and associated separate layer strength and hardness at anticipated elevated service temperatures with insufficient solid state interdiffusion between the respective metal nitride layers to adversely affect the neighboring individual layer structure and layer strength/hardness. Typical anticipated elevated service temperatures in cutting tool applications are up to 1000 degrees C. for purposes of illustration and not limitation, although other elevated (superambient) service temperatures would be anticipated for other service applications such as anti-friction bearing applications.

The first nitride layer 12 and the second nitride layer 14 can comprise a metal or non-metal (e.g. boron) nitride layer. One approach for selecting particular nitrides for the first and second metal nitride layers can be on the basis of immiscibility of the respective first metal and a second metal of the nitrides involved. In particular, the first metal and second metal are selected to comprise immiscible elemental metals in the liquid or solid state under typical equilibrium conditions. Examples of such immiscible metals are chromium and molybdenum that can provide a first metal nitride layer comprising Cr and N (e.g. CrN) and a second metal nitride layer comprising Mo and N (e.g. Mo₂N), respectively, that will exhibit similar immiscibility. Other immiscible metals include, but are not limited to, Cr and W to provide first and second metal nitride layers that comprise Cr and N (e.g. CrN) and W and N (e.g. W₂N), respectively, and Ti and Mo to provide first and second metal nitride layers that comprise Ti and N and Mo and N, respectively.

A composite coating in accordance with an embodiment of the present invention also includes the feature that one or both of the first layer or second layer includes a component that is preferentially oxidizable at the contact surface at elevated service temperatures when the contact surface of the coating is in sliding contact with another material. The component is sufficiently oxidizable to form a friction-reducing lubricious oxide material at the contact surface during service to reduce the coefficient of friction (COF) at the contact surface. For example, the metal or non-metal component of one of the first metal nitride and the second metal nitride is oxidizable to this end. Such a preferentially oxidizable metal component comprises Mo when one of the nitride layers comprises Mo₂N. The component typically is preferentially oxidizable in air or or other ambient atmosphere that contains oxygen, even an inert or nitrogen atmosphere that contains a small amount of oxygen as described below.

The composite coating optionally can include oxidizable nitride dispersoids in one or both of the first layer or the second layer wherein the nitride dispersoids are sufficiently oxidizable at certain elevated temperatures to form a friction-reducing lubricious oxide material at the contact surface during service to reduce the coefficient of friction (COF) at the contact surface. For example, in FIG. 1, the second nitride layer 14 can be deposited under deposition conditions to form the nitride disperosids (nano-particles) in the each second nitride layer 14. For example, BN nano-particles can be codeposited with each second Mo₂N layer 14 using suitable reactive sputtering conditions and sputtering targets. The nitride dispersoid nano-particles can be selected to be stable until a certain elevated service temperature is reached at which they oxidize to form other lubricious oxides at the contact surface at different temperatures, such as at a lower service temperature than the Mo₂N so that lubricious oxides are formed at the contact surface over a broader temperature range. For example, BN can oxidize at a lower temperature to B₂O₃ to this end.

Moreover, in order to address other service temperature requirements and other workpiece or counterface materials being contacted, the host (dual nitride layer) system can be changed or additions can be made to this host system. For example, the combination of a CrN layer and W₂N layer should behave in a similar way to the CrN/Mo₂N system (the metals Cr and W are immiscible up to temperatures in excess of 1600° C.), except that the stability of the tungsten nitride phase should exceed that of Mo₂N by several hundred degrees, shifting the functionality of the coating to much higher temperatures (where WO₃ is the lubricious oxide analogous to MoO₃). Using additions to the host coating, one can also reduce the temperature for activation of the oxide lubrication. Elements such as B, Ca, P, Bi, Pb, Sn and others can be incorporated, generally as nitride, oxide, carbide, or boride compounds in the host structure to this end. A main requirement is that the compound remain stable and reinforce the strength of the coating until the desired temperature is reached. It must also be added in a form that favors the oxide formation at the desired temperature relative to the compound existing in the coating. As an example, boron can be added as a nitride dispersoid phase such as BN, which will be stable until exposed to oxygen at some temperature, where it will then prefer to oxidize to B₂O₃, and in the presence of water molecules, further transform to boric acid which is known to be very lubricious.

The first nitride layer 12 and second nitride layer 14 typically are selected to have an individual hardness measured at room temperature in the range of 20 GPa to 30 GPa for purposes of illustration and not limitation. For example, in accordance with an illustrative embodiment of the present invention, each frist nitride layer 12 can comprise chromium nitride represented by CrNx where the structure of CrNx can be that of the compounds CrN or Cr₂N or a mixture of the two compounds and each second nitride layer 14 can comprise molybdenum nitride represented by MoNx where the MoNx phase can have the structure of Mo₂N or MoN or a mixture of the two compounds. The value of “x” can vary to some extent in either CrNx and/or MoNx and still be identified as the compound MN or M₂N where M is the metal (e.g. Cr or Mo). In a preferred embodiment, the chromium nitride comprises CrN which has excellent hardness and is stable and oxidation resistant in air up to about 800° C., while the molybdenum nitride comprises Mo₂N, which has excellent hardness and is stable in air to about 450-500 degrees C. where it begins to oxidize, forming its low friction Mo-oxide such as MoO₃. The formation of the Mo-oxide will reduce the cutting friction and consequently the heat generated by high-speed contact compared to a coating without the Mo oxide-forming capability. These nitrides exhibit appropriate immiscibility that extends to at least 1000 degrees C.

Although the first nitride layer 12 and second nitride layer 14 typically are selected to have an individual hardness measured at room temperature in the range of 20 GPa to 30 GPa for cutting tool applications, the invention is not limited to this range of hardnesses since one or both of the nitride layers/materials can have a different (e.g. higher or lower) hardness and still be useful in practice of the invention as long as the overall coating stress is maintained low enough to avoid delamination under applied load and the coating is tough (fracture resistant) under load. For bearing surfaces (as opposed to cutting tool surfaces), different limits on the range of hardnesses of the layers/materials may be selected in practice of the invention (e.g. for purposes of illustration and not limitation, 5 GPa to 10 GPa individual layer hardness at room temperature for bearing applications).

The detailed behavior of the composite coating will be a function of both the structure of the coating (volume fraction of each nitride phase and distribution of nitride phases), and the operating conditions (sliding speed, load, material). It is expected that additions of other materials can tailor the use of the coating for different counterface or workpiece materials depending on their temperature handling ability (e.g., aluminum vs. steel) and their affinity for the coating material (e.g, adhesion at contact).

Referring to FIG. 2, the invention envisions in accordance with another embodiment of the present invention a cutting tool 50 comprising a tool substrate 52 and the above coating 10 on the substrate so that little or no lubricant from an external source is required for maching a metallic or other workpiece W and a method of cutting a metallic or other workpiece using the cutting tool. The coating layers 12 and/or 14 optionally can include nano-particle dispersoids such as BN or other nitride dispersoids codeposited therein. The contact areas are on the rake face where the metal curls away from the tool face as shown and on the flank face where the work-piece slides past the tool point. The former contact is apparent in FIG. 2, while the latter is not so evident since we only see the point contact in the idealized figure. Both contact areas can get exceedingly hot depending on the work-piece and the operating conditions (depth of cut and speed). The friction at these points of contact determines the excess energy used in the cutting process. Practical operating temperatures have been estimated in the range of 300° C. to greater than 1000° C. for cutting steel, and of course, much lower for cutting low-melting metals, such as aluminum.

The invention also envisions in another embodiment a bearing surface that comprises a load-bearing substrate and the above described coating on the substrate to reduce friction. in the presence of sliding action of one surface over another as in a bearing. Such service applications are expected to be found in bearings where dry sliding, either by necessity or in boundary lubrication conditions due to temporary lack of lubrication, exists under heavy loads or high speeds or both. In these applications, where the localized high temperatures can cause asperity welding and serious adhesive wear, coatings pursuant to the invention can play a critical role in preventing catastrophic failures. The invention envisions numerous service applications in power, transmission components, especially in environments where it is difficult to maintain lubrication due to high temperatures and the inability to seal and cool components. Industry segments include, but are not limited to, transportation, heavy equipment, earth drilling, and manufacturing equipment. Of course, the invention envisions a variety of other service applications where loading is not on the scale of traditional heavy industry needs, but specialized in components serving aerospace or even micro-machines, perhaps in high-speed sliding contacts with lower loads, but local high temperature contact spots. Typically, the bearings are described as conformal or non-conformal, but in all cases it is local asperity contacts (depending on surface roughness/topography) that will be the sites for localized heating, and which, if coated pursuant to the invention, offer the potential for oxide formation that will reduce friction under dry conditions. The design of the contact surface area of the bearing will affect how the oxide is retained in the contact region or is expelled, requiring its renewal by further oxidation.

The following Examples are offered to further illustrate and not limit the present invention.

### EXAMPLES

Samples were prepared by sputter deposition in a closed-field dual cathode unbalanced magnetron system. The cryo pumped system has a base pressure of 4×10⁻⁷ Torr and includes a high vacuum load lock chamber. There are two vertically mounted 12.8×40.6 cm planar magnetron cathodes facing each other on opposite sides of the substrate holder and 10 cm from the substrates. The hexagonal substrate holder is just large enough to eliminate the cross contamination from the other cathode. The substrate holder can be rotated at 5-15.2 rpm to produce nano-layered materials with controlled layer thickness. All coatings were 1 to 1.5 μm thick in total thickness. The substrates were single crystal Si (001), glass sides, and polished M50 tool steel discs. Sapphire substrates were used in cases where high temperature anneals were to be carried out. Prior to deposition the samples were cleaned in an ultrasonic bath of methanol. All reactive sputter depositions were carried out under a total pressure of 4 mTorr of argon and nitrogen. A −50V bias was applied on the substrate and the substrate temperatures due to plasma heating were generally in the 150° C.-200° C. range. The oxidation anneals were carried out in air and held at the highest temperature for 2 hrs with a heat up rate of 5° C./min. The annealing tests on the multilayers were carried out in argon and held at the highest temperature for 2 hrs with a heat up rate of 5° C./min. A CETR micro-tribometer is used to measure the coefficient of friction (COF) at room temperatures while a CSEM high temperature tribometer is used for high temperature tests. Both tribometers are the “pin on disc” type. Room temperature friction tests on the nitrides and oxides of both Mo and Cr were carried out using a steel ball (52100 steel, 3 mm diameter, 20-25 gm load) run on the rotating coated M50 steel flat (25.4 mm dia). High temperature friction tests on the multilayers were carried out using a sapphire ball (3 mm diameter, 40 gm load). The linear velocity is kept constant at 1 cm/sec by adjusting the rotation speed in all tests. X-ray diffraction (XRD) was carried out using a Scintag XDS diffractometer having an unfiltered Cu—Kα radiation source operated at 40 kV and 20 mA. Coating hardness was determined using a CSIRO UMIS 2000 nano-indenter fitted with a Berkovich diamond tip. The indentations depths are kept within 10% of the coating thickness to eliminate any substrate effects such that hardness values are independent of substrate. The film thickness on the Si substrate was measured using a Dektak 3030ST profilometer at the edge of a masked section of the substrate. XPS phase identification of CrNx phases was done using a Omnicon ESCAPROBE. It is equipped with single channeltron detection and a twin-anode X-ray source (Al/Mg anode, 400 W). All XPS spectra were referenced to the C 1s line of hydrocarbon-type carbon. SEM characterization was carried out on a LEO-Gemini 1525.

### A. Molybdenum Oxide Films:

Molybdenum oxide (MoO₃) layer was deposited and characterized initially since this oxide phase provides the lubricious oxide at the contact surface of the coating pursuant to the invention. Initially, Mo-oxide films were deposited directly by reactive sputtering and analyzed to determine the phases that were likely to appear as oxidation products. The oxide samples were then annealed in air at several different temperatures to determine their stability at different temperatures. This also allowed study of any physical changes that might occur to the oxides as a result of heating (up to 600° C.). Following these treatments and characterization, the sliding friction of this oxide phase was tested.

### Phase Characterization:

The reactive sputtering was carried out in an atmosphere of 0.3 mTorr oxygen and a total pressure of 4 mTorr (O₂+Ar), on an M50 steel substrate with a substrate bias of −50V. The XRD results confirmed that MoO₂ and Mo₄O₁₁ were deposited under these conditions. Annealing the coating at 250° C. formed MoO₃ and Mo₄O₁₁ as the predominant phases. Further annealing to 550° C. sharpened and intensified the peaks, but MoO₃ became the dominant phase. There were peaks that can be possibly identified with other phases such as Mo₈O₂₃/Mo₉O₂₃ with the identification being uncertain, via XRD, due to overlapping peak positions for some of these complex phases. Annealing increased the surfaces' roughness from 25 nm in the deposited coating to 100 nm and 350 nm at 550° C. and 600° C. respectively. Hardness was a low 3-4 GPa and it is likely that the oxide was weakly adhered to the substrate in addition to being very weak itself. Again the higher value of hardness occurred after annealing at the highest temperature, which is indicative of some stress relief and recrystallization.

### Tribological Behavior of Mo-Oxide Films:

Sliding wear tests on the Mo-oxide surfaces demonstrated that the combination of MoO₂ and Mo₄O₁₁ as deposited shows a low COF value of less than 0.15. While it was expected that the MoO₃ surface would exhibit low friction, it was unclear what to expect from the other oxides such as MoO₂, which are stable to relatively high temperature. As the film is annealed, the friction plots get noisier, apparently due to structural changes in the oxide. When annealed at about 550° C., where the oxide is predominantly MoO₃, the friction again was a stable value of about 0.1-0.12. The low friction behaviour of MoO₃ thus was demonstrated.

### B. Chromium Oxide Films:

Since chromium nitride is one of the constituents in the preferred multilayer coating, it is desirable to explore the oxidation process on the CrNx films where Cr₂O₃ is the expected product of CrNx oxidation but not unless and until the coating reaches about 800-900 degrees C. Nevertheless, it was desirable to confirm mechanical and friction properties of the oxide, since this could give some insight into the wear processes in the multilayer and the role played there by the Cr₂O₃ formed there. Cr₂O₃ films were reactively sputtered on an M50 substrate at various partial pressures of oxygen and a total pressure of 4 mTorr (O₂+Ar) with a substrate bias of −50V. Hardness of the as deposited sample was about 25 GPa which on annealing at 200° C. dropped to 15 GPa. Further annealing lead to an increase in hardness to 18 Gpa, 20 Gpa and 30 Gpa at temperatures of 250° C., 400° C. and 600° C. respectively. The drop in hardness initially on annealing could be indicative of stress relief as defects migrate to free surfaces or interfaces. Friction tests on the coating shows that Cr₂O₃ removes material from the ball fairly rapidly and a “steady state” condition is reached quite rapidly. The COF value appears in the 0.6-0.7 range. The friction value has a component of metal on metal sliding involved since metal-metal sliding lies in the 0.6 to 0.8 range. Metal transfer was confirmed via EDS and optical microscopy.

### C. Mo-Nitride Films:

Since molybdenum nitride is one of the constituents in our multilayer coating, it is desirable to explore the oxidation process on the MoNx films. The different phases of Mo and N were reactively sputtered at different partial pressures of nitrogen forming β-Mo₂N, γ-Mo₂N and Mo-Nx which is Mo bcc (body centered cubic) containing solid solution N and retaining the crystal structure of Mo metal.

At low partial pressures of 0.3 mTorr N₂, a coating of Mo-Nx is formed which is Mo bcc structure with nitrogen incorporated into the lattice and which retains the crystal structure of Mo metal.

At intermediate nitrogen partial pressures of (1-2) mTorr, β-Mo₂N (hexagonal) nitride was deposited. At nitrogen partial pressures of 2 mTorr and above, γ-Mo₂N (tetragonal) nitride was deposited. Combinations of β-Mo₂N and γ-Mo₂N could exist under intermediate conditions.

### D. Heat Treating in Air

The oxidation products and oxidation temperatures of Mo₂N are reported by N. Solak, F. Ustel, M. Urgen, S. Aydin, A. F. Cakir, Surf. Coat. Techn, 174-175 (2003); by Zhengwei Li, Yedong He, and Wei Gao, Oxidation of metals, Volume 53, Nos. 5/6, 2000; and by T. Suszko, W. Gulbinki, J. Jagielski, Surf. Coat. Tech. 200, (2006), 6288. The air annealing of the Mo-Nx (Mo with solid solution N) at 650 degrees C. was studied since it showed the lowest COF at room temperatures. Annealing Mo-Nx showed that the MoO₂ phase and possibly the Mo₄O₁₁ phase appear first, but up to 400° C., the dominant structure is still Mo-Nx. At 650° C., nearly complete oxidation was observed with a dominant MoO₃ peak and Mo₄O₁₁.

### E. Tribological Behavior of MoNx Films:

Mo-Nx film comprising Mo with N in solid solution was found to exhibit a lower friction coefficient of 0.16 to 0.18. Nitride phases such as β-Mo₂N and γ-Mo₂N showed a COF of about 0.7. Friction testing on annealed Mo-Nx sample in air (held at 400° C. for 1 hr) indicates a friction coefficient around 0.12. Though the XRD data does not indicate any oxidation products, there is a marked difference in the nature of the friction curve. The curve is markedly noisier with indication of early breakdown and a gradual increase of friction to 0.6-0.7, suggesting a possible loss of the coating. It appears that the transformation from the nitride to the oxide might not yield a surface quite as stable (mechanically) as the as-deposited oxides, but the resultant friction is still quite low. The properties of Mo-Nx film comprising Mo with N in solid solution suggest that it is not very hard (12 GPa), whereas MoNx nitride films can be deposited with hardness values in the 20-30 GPa range.

### F. Deposition of Phases of MoNx and CrNx

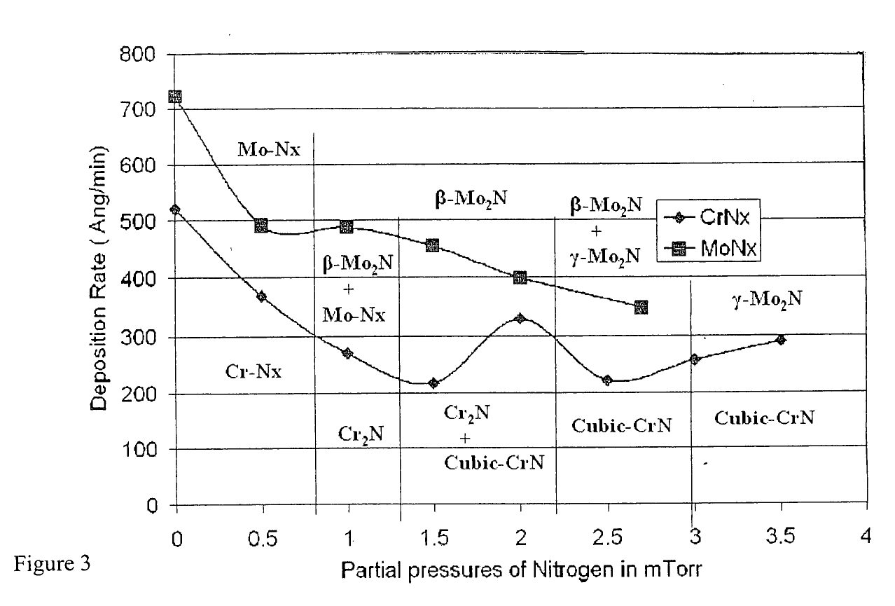

The powers on the chromium and molybdenum cathodes were set at 2.1 kW and 3.5 kW respectively. The total pressure was held constant at a 4 mTorr pressure (Ar+N₂) and the substrate bias was a constant −50V. It is critical to understand the effect of nitrogen partial pressures on the formation of the nitrides since the reactivity of Cr and Mo to nitrogen is different, FIG. 3. Varying the partial pressure of nitrogen allows one to characterize the deposition rates of the different phases of both CrNx and MoNx. The deposition rates control the relative thickness of the two phases. XPS was carried out to determine the exact phases of chromium nitride at intermediate nitrogen partial pressure, since an XRD analysis failed in identifying the phases present because of peak broadening and overlap. The Cr 2p_{3/2} in the 1.0 mTorr to 2.0 mTorr range of reactive sputtering pressure can be decomposed into two components from Cr₂N (576.24 eV compared to reference value of 576.1 eV) and CrN (575.24 eV compared to the reference value of 575.5 eV). With increasing partial pressure the peak shifts from the Cr₂N to the CrN peak.

In the case of Mo deposited at partial pressures of less than about 0.8 mTorr of nitrogen, Mo-Nx, the Mo bcc phase with nitrogen incorporated into its lattice, is found. At intermediate nitrogen partial pressures of around 1 mTorr, a mixed phase of Mo-Nx comprising Mo with N in solid solution and Mo₂N nitride is found. At pressures of 1.5 mTorr of nitrogen, the hardest phase of β-Mo₂N is found. At higher partial pressures of 2 mTorr and above nitrogen, the γ-Mo₂N phase is forming, initially in combination with the β-Mo₂N and at higher partial pressures it exists as the predominant phase. Similar phase regions of Cr-Nx (solid solution of nitrogen in Cr), Cr₂N and CrN are depicted in FIG. 3. The vertical line shown in FIG. 3 depicts approximate phase regions.

### G. Nanostructured Multilayered Films Pursuant to the Invention

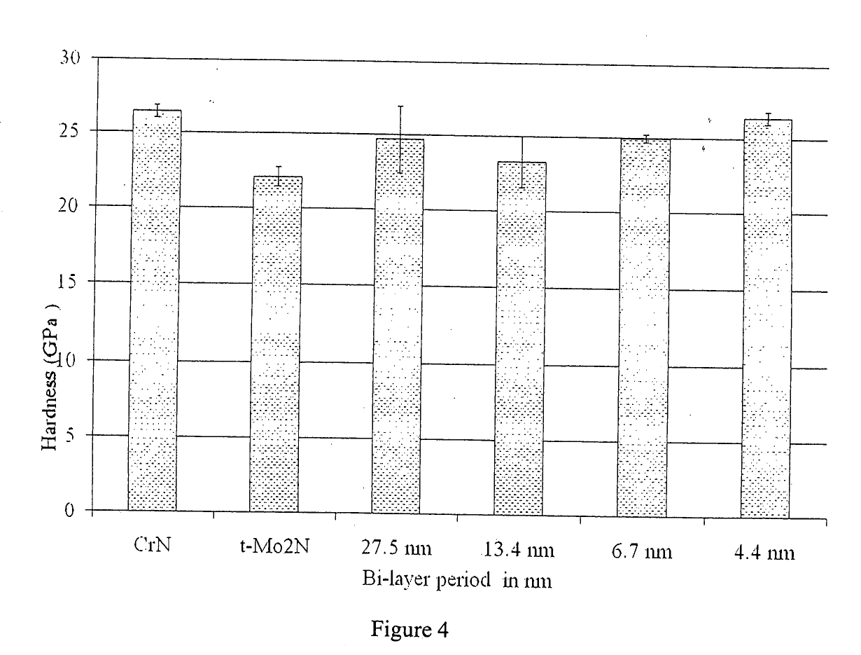

Nanolayered coating of the type illustrated in FIG. 1 was deposited via reactive sputtering at an intermediate partial pressure of 1.5 mTorr. The total pressure was held at a constant 4 mTorr (Ar+N₂) and the substrate bias was a constant −50V. Sapphire substrates were used in samples that were annealed to high temperatures; Si wafer substrates were used for hardness test samples. The chromium and molybdenum targets were set at powers of 2.1 kW and 3.5 kW. This is the regime where the hardest phase of β-Mo₂N nitride and a combination of CrN and Cr₂N nitrides are formed, with CrN being the dominant nitride phase. Different nanolayer bi-layer periods (e.g. 27.5, 13.42, 6.7, and 4.4 nm) were synthesized at different rates of rotation of the substrate holder where bi-layer period is the total thickness of the two adjacent first and second nitride layers. The hardnesses of the films were in excess of 25 GPa making them suitable for tool coatings, FIG. 4. Also, the hardness does not depend strongly on the bi-layer period so that variation in the bi-layer period over the coating surface (e.g. curved surface, or irregular surface) will not result in hardness variations over the surface.

Low angle XRD studies showed strong large order multiple reflections indicative of a sharp interface. A series of high temperature anneals were carried out to understand the temperature effects on the interface and the coatings in general. These anneals were carried out in an atmosphere of argon with the sample held at high temperature (200° C., 400° C., 600° C., 1000° C.) for 2 hours. Low angle XRD shows strong interaction peaks to several orders indicating that the interface is stable to 600° C. Low angle XRD on the sample at 1000° C. indicates a loss of these fringes. SEM imaging of the cross section of these annealed coatings shows that the layers are still intact at 1000° C., and the loss of low angle XRD fringes is likely due to an increase in surface roughness, since low angle XRD is extremely sensitive to surface roughness. The nano-layered structure thus was shown to be intact up to 1000° C.

### H. Friction Tests Nanostructured Multilayered Films Pursuant to the Invention

Sliding tests on a nanolayered coating of paragraph G. were carried out on the high temperature CSEM Tribometer using a sapphire ball. A 40 gm load was applied with the sample rotated relative to the ball such that the ball maintains a linear velocity of 1 cm/s. The coating tested had a CrN/Mo₂N bilayer period of 13.4 nm with a ratio of layer thickness of 3:2 (Mo₂N:CrN). The friction initially increases from a value of about 0.4 at room temperature, to a high of about 1.0 at 300° C., and then drops to a steady value of about 0.55 when tested at 600° C. An in-situ activated lubrication mechanism thus is observed. The oxidation of the nitride phase appears to be responsible for the low friction seen in the test. Preliminary XPS studies of the wear debris obtained at 550° C. indicate the presence of the Mo 3d_{3/2} at 233 eV, which peak is MoO₃.

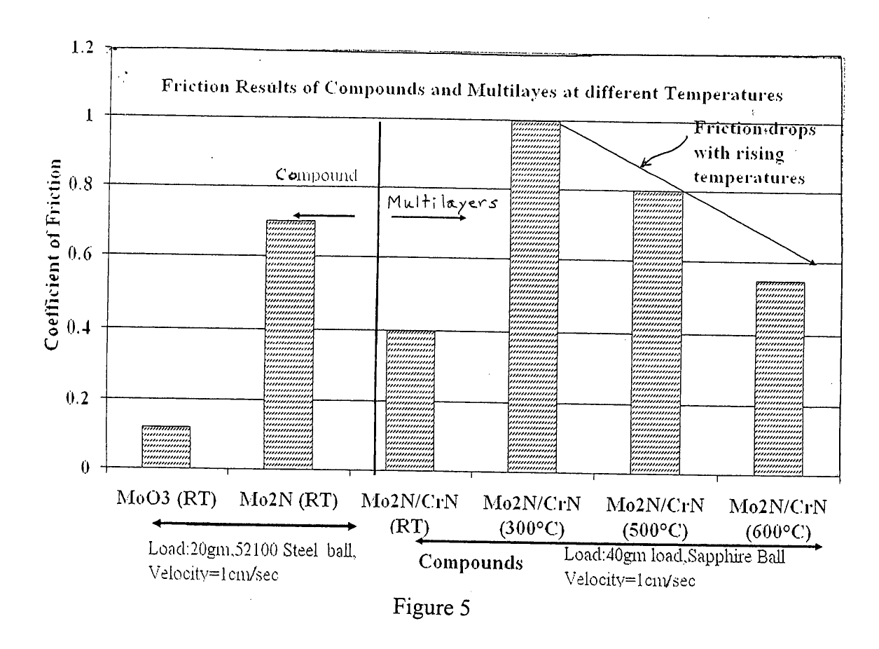

Referring to FIG. 5, sliding tests also were conducted on a nanolayered coating comprised of CrN/Mo₂N layers having a bilayer period of 26 nm with a ratio of layer thickness of 2:1 (Mo₂N:CrN) deposited in a manner similar to that described above. The friction tests were carried out on the high temperature CSEM Tribometer using a sapphire ball. A 40 gm load was applied with the sample rotated relative to the ball such that the ball maintains a linear velocity of 1 cm/s. As shown in FIG. 5, the friction initially increases from a value of about 0.4 at room temperature, to a high of about 1.0 at 300° C., and then drops to a steady value of about 0.55 when tested at 600° C. An in-situ activated lubrication mechanism thus again is observed. For comparison, in similar friction tests of similar coatings but where one coating had a bi-layer period of 12 nm and ratio of layer thickness of 10:3 (Mo₂N:CrN) and the other coating having a bi-layer period of 18 nm and ratio of layer thickness of 5:4 (Mo₂N:CrN), the test area was flooded with nitrogen cover gas and resulted in a 10-20% decrease in friction relative to the friction already seen in air apparently by slowing or buffering the oxidation of the contact surface of the coating.

Although the invention has been described above with respect to certain embodiments, those skilled in the art will appreciate that the invention is not limited to these embodiments and that changes and modifications can be made hereto within the scope of the invention as set forth in the appended claims.

1. A coating having a first layer comprising a first nitride and a second layer comprising a second nitride wherein the first nitride and the second nitride are sufficiently immiscible to maintain respective layer individuality at an elevated service temperature when a contact surface of the coating is in sliding contact with another material and wherein one of the first layer or second layer includes a component that is oxidizable at the contact surface to form a friction-reducing lubricious oxide at the contact surface.

2. The coating of claim 1 wherein the first nitride comprises a metal nitride.

3. The coating of claim 2 wherein the metal nitride comprises CrN.

4. The coating of claim 1 wherein the second nitride comprises a metal nitride.

5. The coating of claim 4 wherein the metal nitride comprises Mo₂N

6. The coating of claim 1 wherein one of the first nitride or second nitride comprises comprises a non-metal nitride.

7. The coating of claim 6 wherein the non-metal nitride comprises BN.

8. The coating of claim 1 wherein the first layer and the second layer are deposited one on the other in a repeating pattern to provide a multi-layered coating.

9. The coating of claim 1 wherein the first nitride and the second nitride each has a thickness in the range of 1 to 30 nanometers.

10. The coating of claim 1 wherein the first nitride and the second nitride each has a hardness at room temperature in the range of 20 GPa to 30 GPa.

11. A cutting tool comprising a tool substrate and the coating of claim 1 on the substrate.

12. A bearing surface comprising a load-bearing substrate and the coating of claim 1 on the substrate.

13. A method of cutting a workpiece using a coated cutting tool, comprising contacting a contact surface of a coated cutting tool and the workpiece while providing little or no lubricant from an external source, wherein the coating comprises a first layer comprising a first metal nitride and a second layer comprising a second metal nitride and wherein the first metal nitride and the second metal nitride are sufficiently immiscible to maintain respective layer individuality at elevated cutting temperature when the contact surface of the coated cutting tool is in cutting contact with the workpiece and wherein one of the first layer or second layer includes a component that is oxidizable at the contact surface to form a friction-reducing lubricious oxide at the contact surface.

14. The method of claim 13 wherein the first nitride comprises a metal nitride.

15. The method of claim 14 wherein the metal nitride comprises CrN.

16. The method of claim 13 wherein the second nitride comprises a metal nitride.

17. The method of claim 16 wherein the metal nitride comprises Mo₂N

18. The method of claim 13 wherein one of the first nitride or second nitride comprises a non-metal nitride.

19. The method of claim 18 wherein the non-metal nitride comprises BN.

20. The method of claim 13 wherein the first layer and the second layer are deposited one on the other in a repeating pattern to provide a multi-layered coating.

21. The method of claim 13 wherein the first nitride and the second nitride each has a thickness in the range of 1 to 30 nanometers.

22. The method of claim 13 wherein the first nitride and the second nitride each has a hardness at room temperature in the range of 20 GPa to 30 GPa.

23. The method of claim 13 including controlling oxidation of the contact surface by introducing a cover gas that is not oxygen.
